(19) United States
(12) Patent Application Publication
(10) Pub. No.: US 2008/0193187 A1
(43) Pub. Date: Aug. 14, 2008

(54) Keyboard physical configuration

(75) Inventor: China-Ho Tsai, Sijhih City (TW)

Correspondence Address: Joe McKinney Muncy, PO Box 1364, Fairfax, VA, 22038-1364, US

(73) Assignee: BEHAVIOR TECH COMPUTER CORP.

(21) Appl. No.: 11/812,657

(22) Filed: Jun. 20, 2007

(30) Foreign Application Priority Data
Feb. 14, 2007 (TW) 96202870

(51) Int. Cl. B41J 5/00; G06F 1/16

(52) U.S. Cl. 400/472; 361/680

(57) ABSTRACT

A physical configuration of a keyboard is described. A first keypad portion is selectively connected to a first position or a second position of the keyboard base. A second keypad portion is connected to the keyboard base and adjacent to the first keypad portion. When the first keypad portion is connected to the first position of the keyboard base, the first keypad portion and the second keypad portion form a first position relation between thereof When the first keypad portion is connected to the second position of the keyboard base, the first keypad portion and the second keypad portion form a second position relation between thereof The first position relation is opposite to the second position relation.

### RELATED APPLICATIONS

This application claims priority to Taiwan Application Serial Number 96202870, filed Feb. 14, 2007, which is herein incorporated by reference.

### BACKGROUND

1. Field of Invention

The present invention relates to a physical configuration of a computer keyboard.

2. Description of Related Art

A computer keyboard is an important device to input of text and characters and also to control the operation of a computer system. A conventional keypad (a group of keys or buttons) configuration on the keyboard is fixed, users cannot adjust the keypad configuration according to their demands, but to adapt themselves for the keypad configuration. Therefore, an inconvenience exists when users operate a keyboard with fixed keypad configuration.

### SUMMARY

A keyboard has an adjustable physical configuration. A first keypad portion is selectively connected to a first position or a second position of the keyboard base. A second keypad portion is connected to the keyboard base and adjacent to the first keypad portion. When the first keypad portion is connected to the first position of the keyboard base, the first keypad portion and the second keypad portion form a first position relation between thereof. When the first keypad portion is connected to the second position of the keyboard base, the first keypad portion and the second keypad portion form a second position relation between thereof. The first position relation is opposite to the second position relation.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a keyboard according to one embodiment of this invention;

FIG. 2 illustrates a keyboard (with a different keypad layout) according to embodiment of this invention;

FIG. 3 illustrates a keypad portion of the keyboard in FIG. 1;

FIG. 4 illustrates a cross-sectional view of the keypad portion in FIG. 3;

FIG. 5 and FIG. 6 illustrate detailed designs of the keypad portion in FIG. 3;

FIG. 7 illustrates another keypad portion according to one embodiment of this invention;

FIG. 8 illustrates a keyboard base according to one embodiment of this invention;

FIG. 9 and FIG. 10 illustrate an electrical connection configuration of the keyboard according to one embodiment of this invention;

FIGS. 11-13 illustrates a keyboard and its cross-sectional views according to one embodiment of this invention;

FIG. 14 illustrates a keyboard base according another embodiment of this invention;

FIG. 15 illustrates a bottom view of a keypad portion according another embodiment of this invention; FIG. 16 illustrates a bottom view of another keypad portion according another embodiment of this invention;

FIG. 17 illustrates a side view of a keyboard base according another embodiment of this invention; and

FIG. 18 illustrates an electrical connection configuration of a keyboard according to another embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

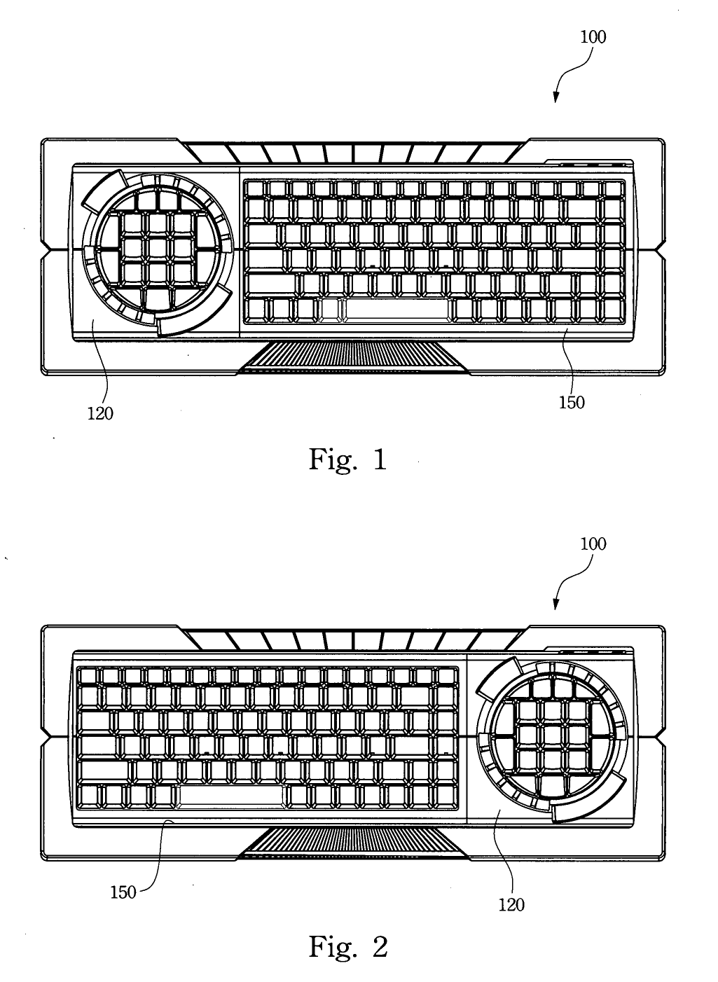

FIG. 1 and FIG. 2 illustrate a keyboard (with different keypad layouts) according to one embodiment of this invention. It is noted that a position relation between a first keypad portion 120 and a second keypad portion 150 in FIG. 1 is opposite to that in FIG. 2. In FIG. 1, the first keypad portion 120 is at left side of a keyboard 100 and the second keypad portion 150 is at right side of the keyboard 100. In FIG. 2 the first keypad portion 120 is at right side of a keyboard 100 and the second keypad portion is at left side of the keyboard 100. How the keyboard 100 is capable of adjusting its keypad configuration, i.e. the position relation between a first keypad portion 120 and a second keypad portion 150, is described below.

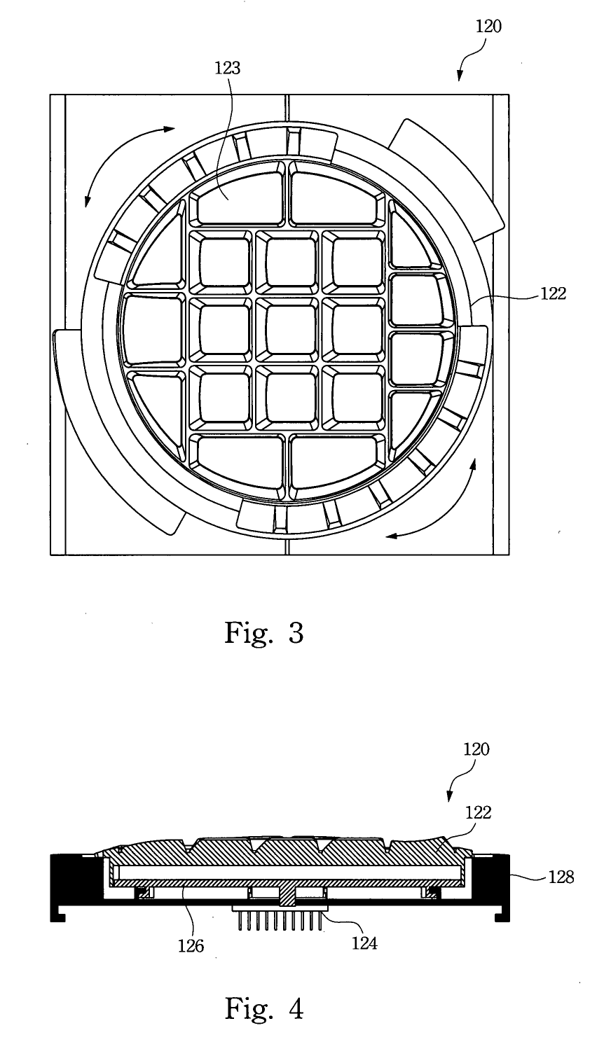

The first keypad portion 120 is described. As illustrated in FIG. 3, the first keypad portion 120 has a rotatable keypad member 122 with a plurality of keys 123. FIG. 4 illustrates a cross-sectional view of the first keypad portion 120. The rotatable keypad member 122 can be rotated by users relative to a fixed member 126. The fixed member 126 is secured on a base member 128 of the first keypad portion 120. The base member 128 has a connector 124.

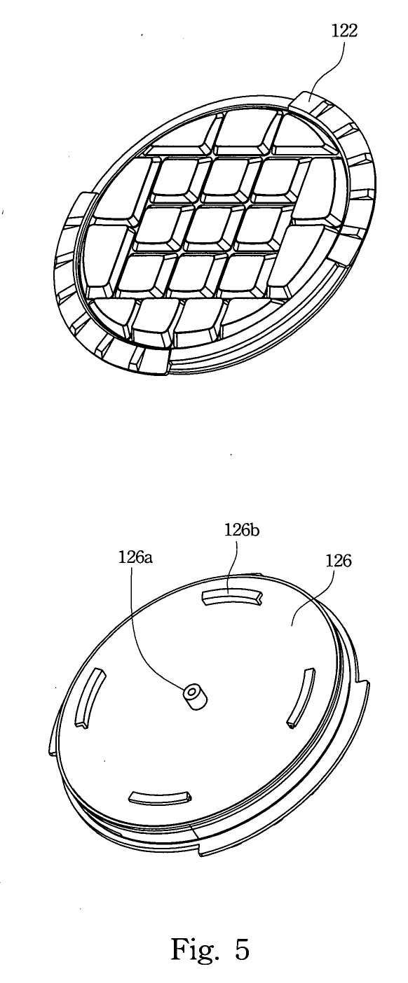

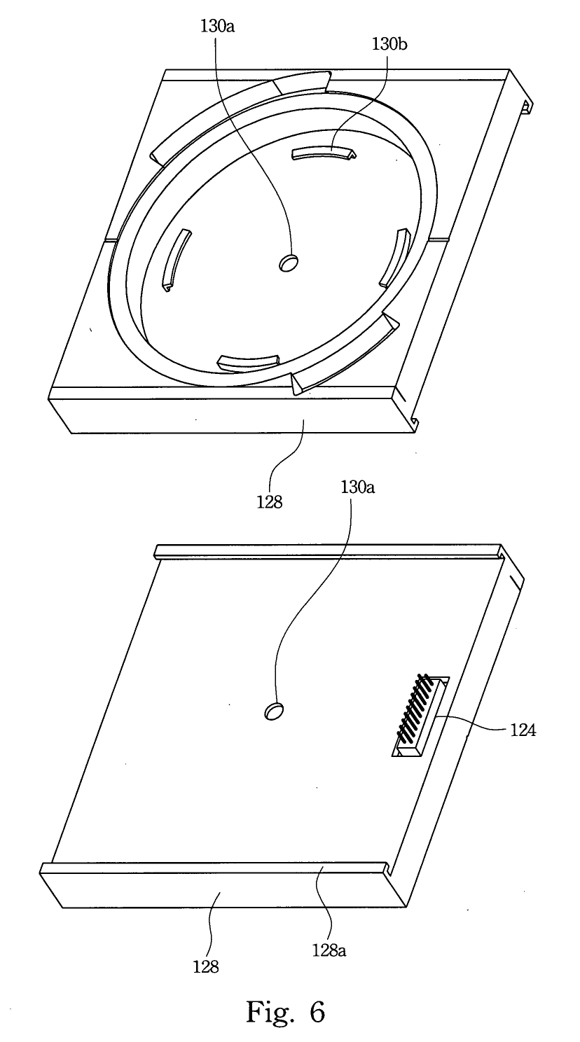

FIG. 5 and FIG. 6 further illustrate detailed designs of the first keypad portion 120. FIG. 5 illustrates a top view and a bottom view of a combination of the rotatable keypad member 122 and the fixed member 126. FIG. 6 illustrates a top view and a bottom view of the base member 128 of the first keypad portion 120. The fixed member 126 has a position pin 126a and several fasteners 126b to engage with a position hole 130a and several fasteners 130b of the base member 128. The position pin 126a is inserted into the position hole 130a. Each of the fasteners 126b engages with each corresponding fastener 130b. The base member 128 has a pair of rails 128a at a bottom side.

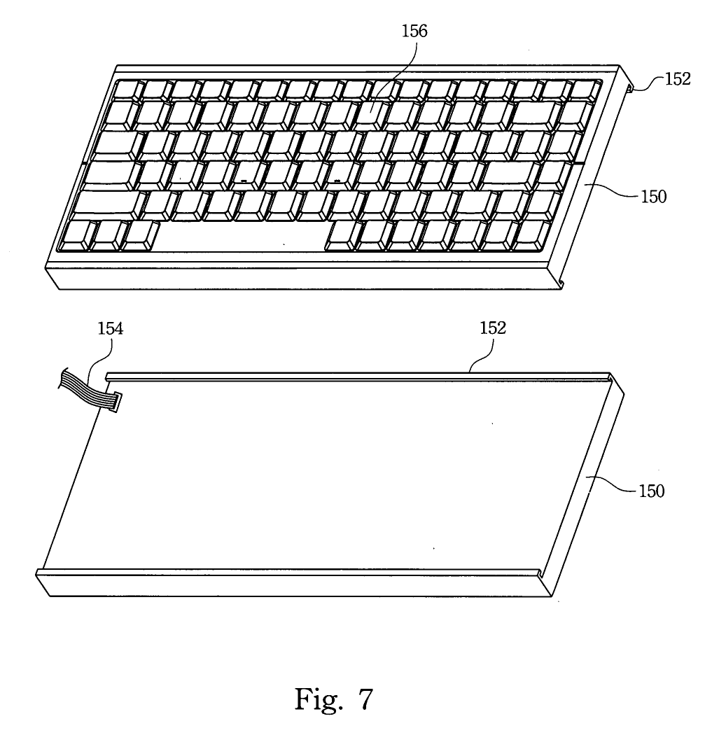

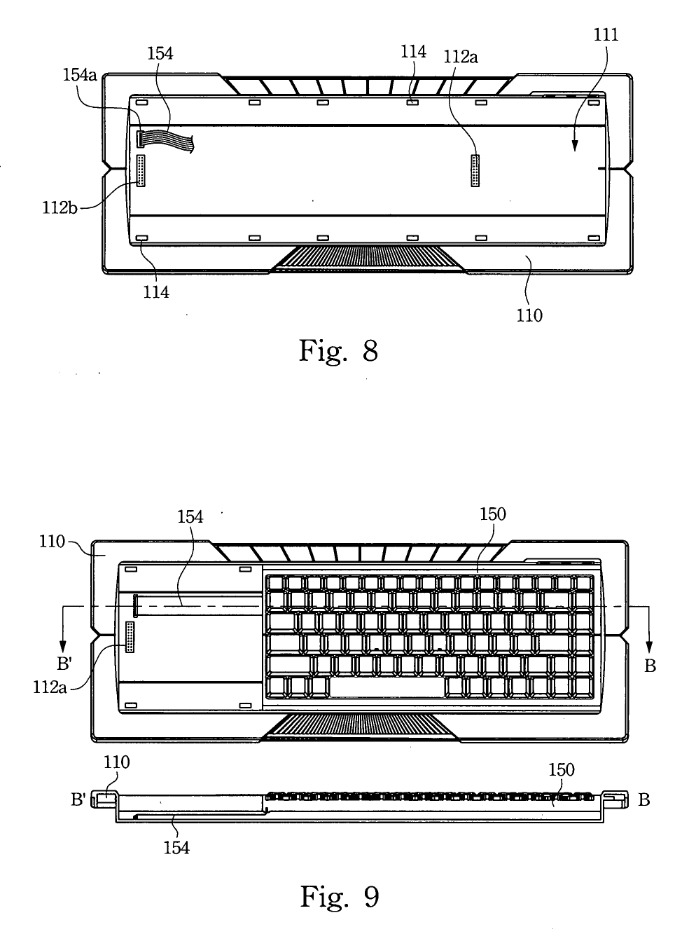

FIG. 7 illustrates a top view and a bottom view of the second keypad portion 150. FIG. 8 illustrates a keyboard base 110. The second keypad portion 150 has more keys 156 than the first keypad portion 120 does. The second keypad portion 150 has a pair of rails 152 at its bottom side to engage with fasteners 114 within a concave section 111 of the keyboard base 110. Therefore, the second keypad portion 150 can be slidingly connected with (cannot be manually-detachable from) the keyboard base 110, and slid along a plane that is substantially parallel to the keyboard base 110. A flexible cable 154 is to electrically interconnect the second keypad portion 150 and a connection section 154a of the keyboard base 110 (within the concave section 111).

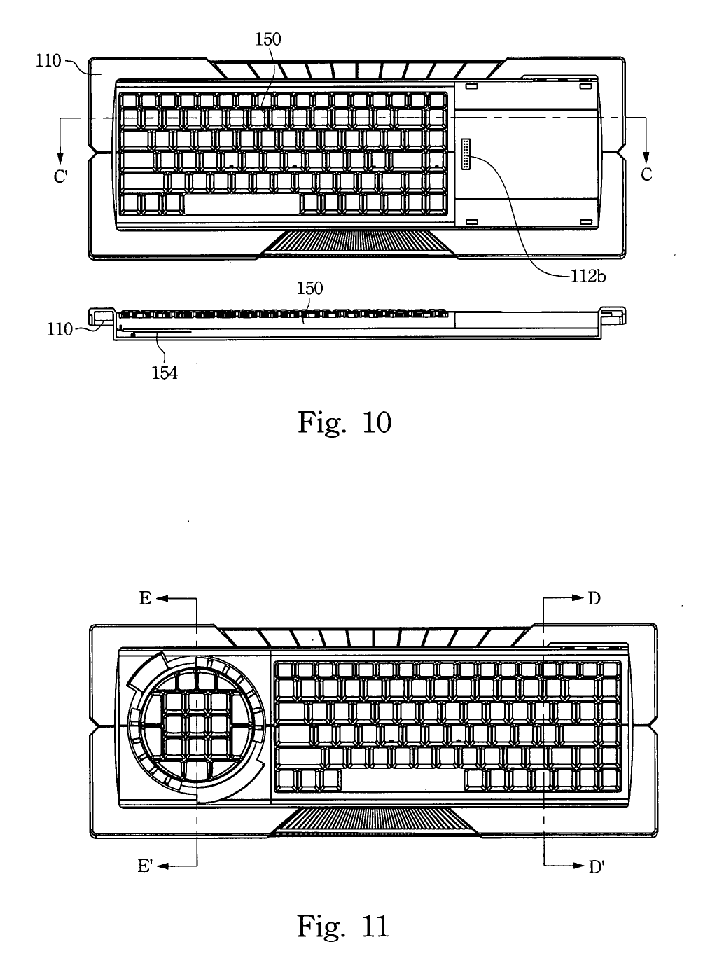

FIG. 9 and FIG. 10 illustrate an electrical connection configuration between the second keypad portion 150 and the keyboard base 110. In FIG. 9, the second keypad portion 150 is slid to the right side of the keyboard base 110, and the flexible cable 154 is pulled as a straight line (cross-sectional view). In FIG. 10, the second keypad portion 150 is slid to the left side of the keyboard base 110, and the flexible cable 154 is overlapped (cross-sectional view). For the overlapped demand (as illustrated in FIG. 10), the flexible cable 154 can be a flexible printed cable or a flexible flat cable.

Please refer to FIGS. 3, 8, 9 and 10. The first keypad portion 120 can be manual-detachably connected to a vacated area (connected to a connection port 112a or 112b) within the concave section 111, which is not occupied by the second keypad portion 150. Thus, two keypad portions can be swapped in position within the concave section 111 of the keyboard base 110.

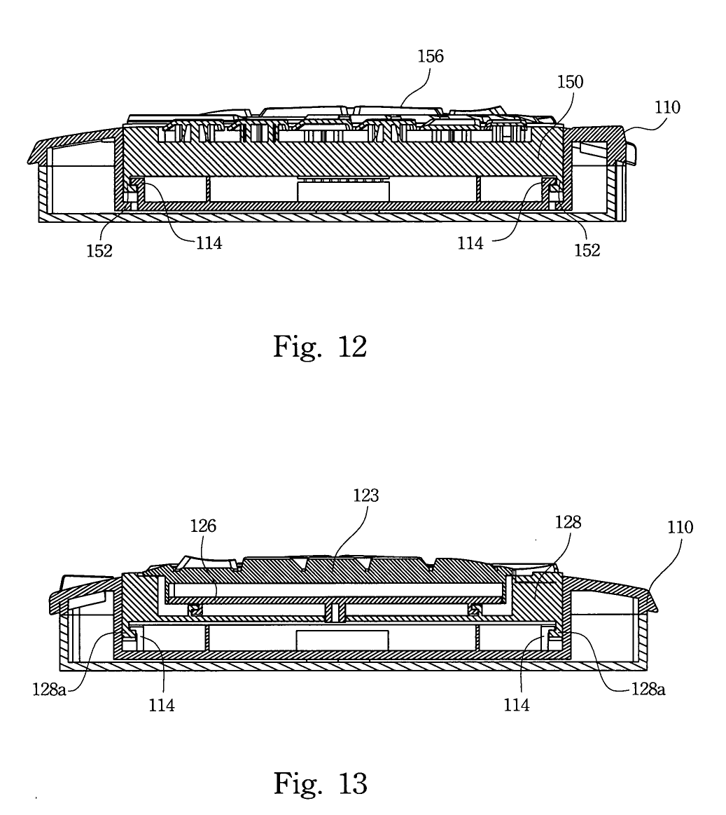

FIGS. 11-13 illustrates a keyboard and its cross-sectional views according to one embodiment of this invention. FIG. 12 illustrates a cross-sectional view taken along the line D-D′ in FIG. 11. FIG. 13 illustrates a cross-sectional view taken along the line E-E′ in FIG. 11. As illustrated in FIG. 12, fasteners 114 of the keyboard base 110 engage with the rails 152 of the second keypad portion 150. As illustrated in FIG. 13, fasteners 114 of the keyboard base 110 engage with the rails 128a of the base member 128 of the first keypad portion.

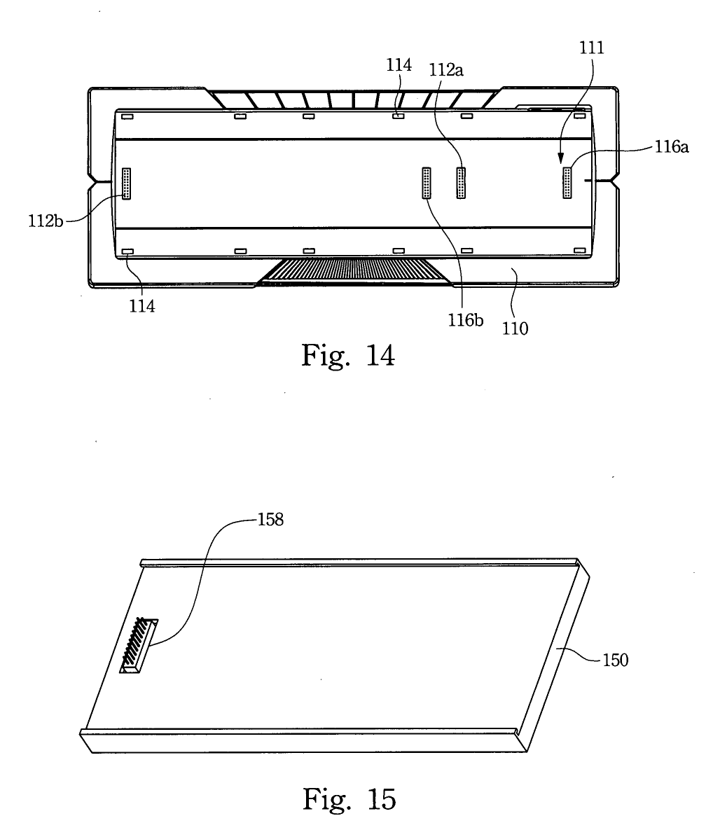

Please refer to FIG. 14 and FIG. 15. The second keypad portion 150 can be manual-detachably connected to the keyboard base 110 besides slidingly connected to the keyboard base 110. That is, the second keypad portion 150 cannot be connected to the keyboard base 110 by the flexible cable (as illustrated in FIGS. 8-10). The second keypad portion 150 is connected to the keyboard base 110 by a connecter 158. The connecter 158 of the second keypad portion 150 is selectively connected to a connection port 116a or 116b. When the connecter 158 of the second keypad portion 150 is connected to the connection port 116a, the first keypad portion 120 is connected to the connection port 112b. When the connecter 158 of the second keypad portion 150 is connected to the connection port 116b, the first keypad portion 120 is connected to the connection port 112a.

Because the first keypad portion 120 and the second keypad portion 150 are separately connected to the keyboard base 110, the first keypad portion 120 and the second keypad portion 150 can be individually used (install either one of them on the keyboard base 110) or collectively used (install two keypad portions on the keyboard base 110) to input data. Besides, two first keypad portions 120 can be installed on the keyboard base 110 to input data.

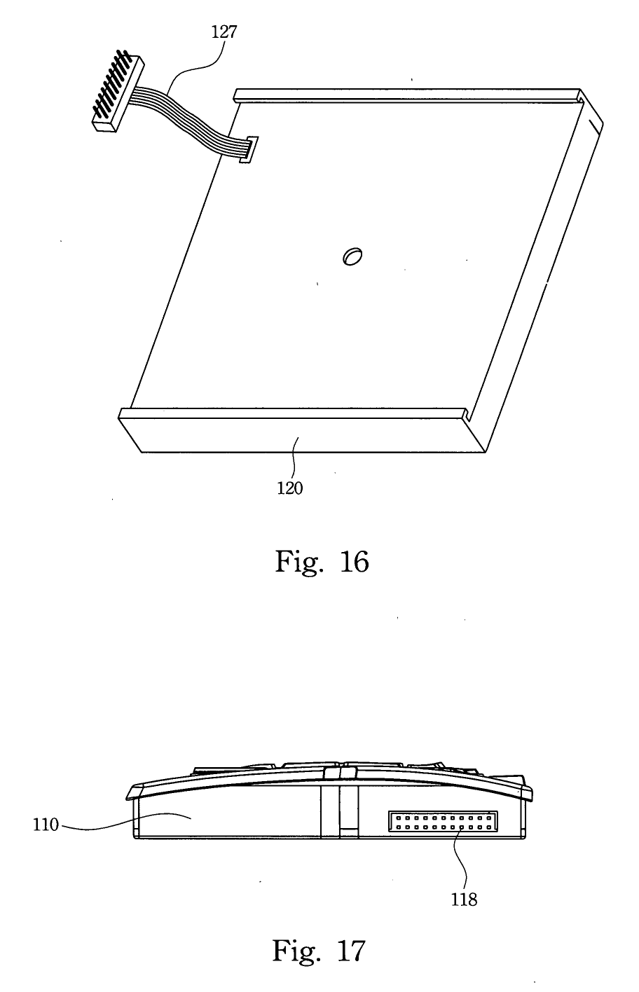

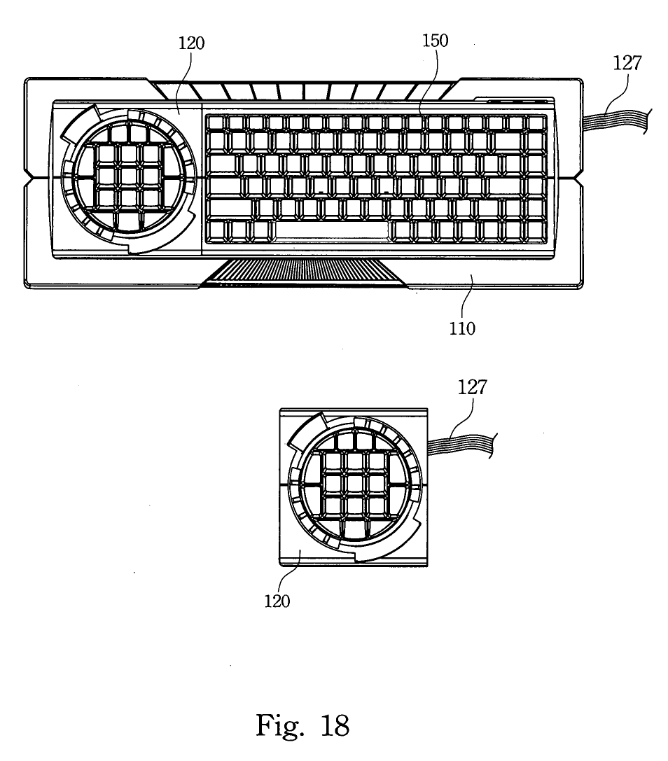

Please refer to FIGS. 16-18, a flexible cable connector 127 (as illustrated in FIG. 16) of the first keypad portions 120 is connected to a connection port 118 on a side portion of the keyboard base 110. Thus, two first keypad portions 120 and one second keypad portion 150 are collectively used (by two users) to input data.

According to embodiments discussed above, the keyboard of the present invention provides an adjustable keypad configuration and a rotatable keypad member such that users can comfortably operate the keys on the keyboard.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A keyboard having a physical configuration comprising:
a keyboard base;
a first keypad portion, selectively connected to a first position or a second position of the keyboard base; and
a second keypad portion, connected to the keyboard base and being adjacent to the first keypad portion,
when the first keypad portion is connected to the first position of the keyboard base, the first keypad portion and the second keypad portion form a first position relation between thereof,
when the first keypad portion is connected to the second position of the keyboard base, the first keypad portion and the second keypad portion form a second position relation between thereof,
wherein the first position relation is opposite to the second position relation.

2. The keyboard of claim 1, wherein the first keypad portion is manual-detachably connected to the keyboard base, the second keypad portion is slidingly connected to keyboard base.

3. The keyboard of claim 2, wherein the first keypad portion comprises a rotatable keypad member having a plurality of keys.

4. The keyboard of claim 3, wherein the keyboard base further comprises a connection port at a side portion, and a flexible cable connector of another first keypad portion is connected to the connection port.

5. The keyboard of claim 2, wherein the keyboard base further comprises a concave section to accommodate the first keypad portion and the second keypad portion.

6. The keyboard of claim 2, wherein the keyboard base further comprises a connection section.

7. The keyboard of claim 6, further comprising a flexible cable to electrically interconnect the second keypad portion and the connection section.

8. The keyboard of claim 2, wherein the second keypad portion is slid along a plane that is substantially parallel to the keyboard base.

9. The keyboard of claim 2, wherein the first keypad portion has fewer keys than the second keypad portion does.

10. The keyboard of claim 2, wherein the keyboard base has two connection ports.

11. The keyboard of claim 1, wherein the first keypad portion and the second keypad portion are both manual-detachably connected to the keyboard base.

12. The keyboard of claim 11, wherein the first keypad portion comprises a rotatable keypad member having a plurality of keys.

13. The keyboard of claim 12, wherein the keyboard base further comprises a connection port at a side portion, and a flexible cable connector of another first keypad portion is connected to the connection port.

14. The keyboard of claim 11, wherein the keyboard base further comprises a concave section to accommodate the first keypad portion and the second keypad portion.

15. The keyboard of claim 11, wherein the keyboard base further comprises a connection section.

16. The keyboard of claim 15, further comprising a flexible cable to electrically interconnect the second keypad portion and the connection section.

17. The keyboard of claim 11, wherein the first keypad portion has fewer keys than the second keypad portion does.

18. The keyboard of claim 2, wherein the keyboard base has four connection ports.

19. A keyboard having a physical configuration comprising:
a keyboard base; and
a keypad portion, disposed on the keyboard base, wherein the keypad portion comprises a rotatable keypad member having a plurality of keys.

20. The keyboard of claim 19, wherein the keyboard base further comprises a connection port at a side portion, and a flexible cable connector of another keypad portion is connected to the connection port.
